(19) United States
(12) Patent Application Publication
(10) Pub. No.: US 2022/0185068 A1
(43) Pub. Date: Jun. 16, 2022

(54) Vehicle Interior Ventilation System and Vehicle

(71) Applicant: Bayerische Motoren Werke Aktiengesellschaft, Muenchen (DE)

(72) Inventors: Florian MIEDL, Moosburg an der Isar (DE); Thomas TILLE, Muenchen (DE)

(21) Appl. No.: 17/432,246

(22) PCT Filed: Feb. 3, 2020
(86) PCT No.: PCT/EP2020/052617

§ 371 Date: Aug. 19, 2021

(30) Foreign Application Priority Data
Feb. 28, 2019 (DE) 10 2019 105 121.5

(51) Int. Cl. B60H 1/00; B60H 1/34; B60H 1/24; B60K 37/02

(52) U.S. Cl. CPC B60H 1/00985; B60H 1/3414; B60K 2370/658; B60H 1/242; B60K 37/02; B60H 1/00792

(57) ABSTRACT

A vehicle interior ventilation system has air outlet slots in a dashboard or a different panel of the vehicle. A display is provided in the dashboard or the different panel, on which display the air flow direction of an airflow resulting from the airflows coming from the air outlet slots can be displayed.

### TECHNICAL FIELD

The invention relates to a vehicle interior ventilation system. It also relates to a vehicle, in particular a motor vehicle, which is equipped with such a vehicle interior ventilation system.

### BACKGROUND OF THE INVENTION

To ventilate the vehicle interior, fresh air is usually drawn in from the outside through a filter by means of a fan and is introduced into the vehicle interior by a system of air guide ducts through air vents provided at different locations of the vehicle interior. Such a vehicle interior ventilation system usually also has heat exchangers of a heating and air-conditioning device in addition to an air filter and a fan. The air vents are generally provided by ventilation slots (for example below the windshield), rigid slat air vents (for example for blowing air onto the front side windows) or movable air vents with manually or electrically adjustable slats for spatially orienting the emerging air flow.

Such movable air vents are often provided in the region of the dashboard. The flow direction of the emerging air can be easily discerned by the vehicle passenger through the visible movable slats of such air vents.

Novel vehicle interior designs are increasingly using so-called interstice vents which do not have any visible slats for adjusting the flow direction of the emerging air. In these interstice vents, the direction of the emerging air is defined by the profile of that section of the air guide duct which is directly upstream of the air vent, the so-called issue duct section. Consequently, the direction of the air flow emerging from these interstice vents can no longer be visually captured. In particular, when a plurality of interstice vents, the emerging air flows of which cross one another, are placed below one another or beside one another, resulting air flows are produced, the flow direction of which differs from the outflow direction from the respective interstice vent. The direction of these resulting air flows also cannot be visually determined by a vehicle occupant. It is therefore difficult for the vehicle occupant to adjust an air flow as desired.

US 2017/0253107 A1 discloses a vehicle interior ventilation system in which a plurality of air outlet slots which run substantially horizontally and are arranged above one another are provided in a dashboard and form such interstice vents. The flow directions of the air emerging from these air outlet slots cross one another outside the dashboard and therefore form a resulting air flow which is directed into the vehicle interior. The direction of this resulting air flow is determined by the flow velocity or the volumetric flow of the air flow respectively emerging from the air outlet slots. The direction of the resulting air flow can be influenced by varying the respective flow velocity.

### SUMMARY OF THE INVENTION

The object of the present invention is to provide a vehicle interior ventilation system of the generic type which makes it possible to visually capture the associated air flow in the vehicle interior even when using air outlet slots which form interstice vents.

This object is achieved with the features of the independent claim.

A vehicle interior ventilation system having at least one fan which is provided in an air guide housing, at least two air guide ducts fluidically connected to the air guide housing and air vents which are fluidically connected to the air guide ducts, wherein at least some of the air vents form air outlet slots in a dashboard or another console of the vehicle which each form the orifice of an issue duct section, and wherein at least one upper air outlet slot and at least one lower air outlet slot are provided in the dashboard or the console, from which the respective air flow emerges in an air outlet direction predefined by the respective issue duct section, and wherein the air flows impinge on one another and form a resulting air flow with a resulting air flow direction, is distinguished by the fact that an upper air sensor is provided for the purpose of capturing the air flow velocity or the volumetric air flow in the upper air guide duct or issue duct section leading to the upper air outlet slot, that a lower air sensor is provided for the purpose of capturing the air flow velocity or the volumetric air flow in the lower air guide duct or issue duct section leading to the lower air outlet slot, that the upper air sensor and the lower air sensor are connected to a control unit of a control device for the purpose of transmitting signals, that the control unit is connected to a display apparatus provided in the dashboard or the console for the purpose of transmitting signals, and that the control unit is designed to determine the resulting air flow direction of the resulting air flow from the captured air flow velocities or volumetric air flows taking into account the respective air outlet direction and to form at least one control signal therefrom for application to the display apparatus.

The vehicle interior ventilation system according to the invention makes it possible for a vehicle occupant to visually detect the air outflow direction or the flow direction of a resulting air flow even when air outlet slots, in particular so-called interstice vents, are provided instead of air vents with visible movable slats. The display apparatus visualizes the resulting flow direction of the resulting air flow that is formed and displays this direction to the occupant.

The dependent claims relate to further preferred advantageous configuration features of the vehicle interior ventilation system according to the invention.

It is particularly advantageous if the display apparatus is formed by light signal elements or at least has light signal elements.

It is also advantageous if the display apparatus has a two-dimensional arrangement of light signal elements as a display panel, on which at least one active signal area can be displayed. Such a two-dimensional display apparatus is formed, for example, by a screen area or a screen region of a so-called smart bar extending over the width or part of the width of the dashboard.

It is also advantageous if the control unit is designed in such a manner that a resulting air flow velocity or a resulting air flow is determined from the magnitude of the air flow velocity or volumetric air flow captured by the respective air sensor, and an area extent control signal is formed therefrom and is applied to the display apparatus in such a manner that the area extent of the active signal area displayed on the display apparatus is dependent on the determined magnitude of the resulting air flow velocity or the resulting volumetric air flow. Such a variable area extent of the active signal area can be intuitively associated by vehicle occupants with the intensity of the resulting air flow flowing into the vehicle interior, wherein a larger area extent of the active signal area is equated with a greater air outlet velocity or a greater volumetric air flow of the resulting air flow. The magnitude of the area extent of the active signal area displayed on the two-dimensional display apparatus therefore correlates with the intensity of the resulting air flow (air velocity or volumetric air flow).

Also advantageous is an embodiment of the vehicle interior ventilation system in which the control unit is designed to control the two-dimensional display apparatus by means of a region control signal in such a manner that an upper region of the display panel has the active signal area if the resulting flow direction is directed upward, that a lower region of the display panel has the active signal area if the resulting flow direction is directed downward, and that a central region of the display panel has the active signal area if the resulting flow direction is directed in a substantially horizontal manner, that is to say to the vehicle occupant's torso.

This embodiment makes it possible for the vehicle occupant to easily capture whether the air flow is directed upward, downward or directly onto his body. The upper region, the lower region and the central region of the display panel need not be discretely separated from one another in this case, but rather the display effected using the active signal area can continuously merge between the respective regions.

In a further advantageous embodiment which can be combined with other embodiments, the light signal elements are designed to reproduce different colors depending on a color control signal. In addition to the previously described location-based and area-based displays on the two-dimensional display apparatus, this development makes it possible to convey additional information to the occupant.

In this case, it is particularly advantageous if the control unit is designed in such a manner that a resulting air flow velocity or a resulting volumetric air flow is determined from the magnitude of the air flow velocity or the volumetric air flow captured by the respective air sensor, and the color control signal is dependent on the magnitude of the resulting air flow velocity or the resulting volumetric air flow. In this manner, the intensity of the emerging air flow can be communicated by selecting a corresponding color of the active signal area.

Alternatively or additionally, at least one temperature sensor can be provided in the air guide housing and/or in the upper air guide duct or issue duct section and/or in the lower air guide duct or issue duct section, and the control unit can be designed to determine a resulting mixing temperature from the values of the air temperature captured by the respective temperature sensor taking into account the respective air flow velocity or the respective volumetric air flow, and the color control signal is dependent on the determined mixing temperature. In this manner, the temperature of the resulting air flow flowing into the vehicle interior is visualized to the occupant on the display apparatus. In particular, when air of a different temperature is guided through the different air guide ducts, a mixing temperature arising in the emerging air can be determined by the control unit, when a temperature sensor is provided in each air guide duct, taking into account the air volumes flowing through the respective guide duct and can be displayed on the display apparatus either numerically and/or by means of a corresponding color signal.

It is particularly advantageous if the display apparatus is arranged in the dashboard or the console between the upper air outlet slot and the lower air outlet slot assigned to the latter. This makes it possible to respectively display the corresponding information for the vehicle occupant in the immediate vicinity of the respective air outlet slots, which is particularly advantageous when different air outlet slots or pairs of upper and lower air outlet slots are provided in a manner distributed over the width of the dashboard or the console. In this case, separate display apparatuses may be assigned to each of these air outlet slots or pairs of upper and lower air outlet slots.

A particularly advantageous development which can be combined with any of the above-mentioned embodiments is distinguished by the fact that the control unit can apply a warning signal to the display apparatus provided in the dashboard, which warning signal causes a priority warning display of the display apparatus. This warning display can be generated completely independently of parameters of the vehicle interior ventilation. This warning signal is advantageously a traffic-related warning signal, for example a signal warning of a rear-end collision or an upcoming end of a traffic jam.

It goes without saying that it is also possible to provide vehicle information other than an input variable for controlling the display apparatus. For example, a driving speed signal can be used to control the color display of the display apparatus, with the result that the color displayed on the display apparatus is an indicator of the current vehicle speed.

The invention is also directed to a vehicle, in particular a motor vehicle, which is equipped with at least one vehicle interior ventilation system designed according to the invention. This at least one vehicle interior ventilation system may be a ventilation system provided in a dashboard, but may likewise be formed by a ventilation system formed in corresponding vehicle consoles in front of a second or further row of seats of the vehicle.

Preferred exemplary embodiments of the invention with additional configuration details and further advantages are described and explained in more detail below with reference to the attached drawing.

### BRIEF DESCRIPTION OF THE DRAWINGS

FIG. 1 shows a schematic illustration of a vehicle interior ventilation system according to an embodiment of the invention as a vertical section through a dashboard of a motor vehicle;

FIGS. 2A to 2C show different operating states of the vehicle interior ventilation system;

FIG. 3 shows a schematic illustration of the control of the display apparatus;

FIG. 4 shows a front view of the dashboard having a display apparatus from the point of view of a vehicle passenger in the direction of the arrow IV in FIG. 1 in a first operating state; and

FIG. 5 shows a front view of the dashboard according to FIG. 4 in a second operating state.

### DESCRIPTION OF PREFERRED EXEMPLARY EMBODIMENTS

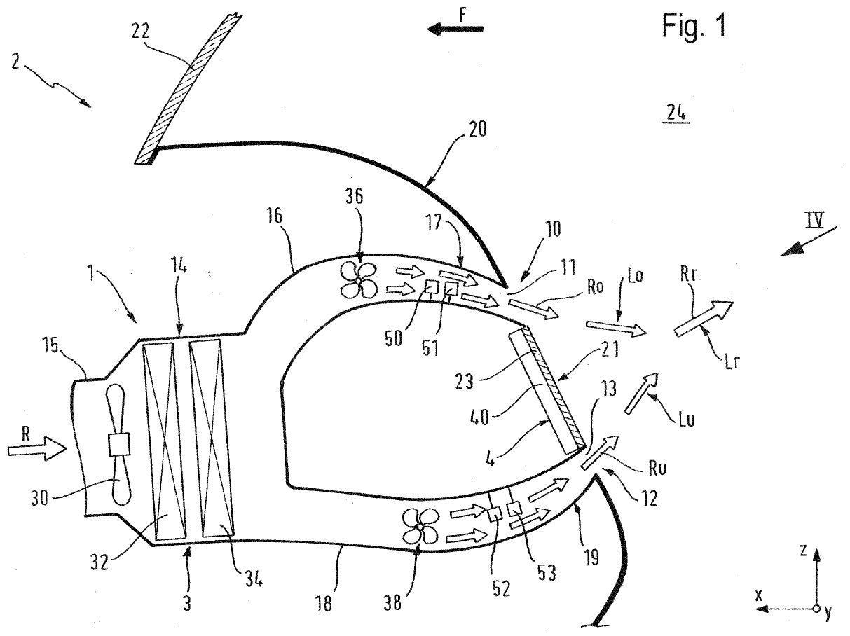

FIG. 1 shows a schematic illustration of a vehicle interior ventilation system 1 as a vertical section through a dashboard 20 of a motor vehicle 2. The front windshield 22 of the motor vehicle 2 is partially illustrated for better consideration and for orientation with respect to the direction of travel F of the motor vehicle 2. An upper air vent 10 and a lower air vent 12, which are both in the form of air outlet slots 11, 13 in the dashboard 20, are shown in the dashboard 20.

The ventilation system 1 has an air guide housing 14 in which a heating, ventilation and cooling unit 3 having a fan 30, a cooling system heat exchanger 32 and a heating heat exchanger 34 downstream of the latter in the direction of air flow R is arranged in a known manner. At its end on the inflow side which leads to an air inlet (not shown), the air guide housing 14 is connected to an air supply duct 15. On the outflow side of the heating, ventilation and cooling unit 3, the air guide housing 14 is connected to an upper air guide duct 16 and a lower air guide duct 18. It goes without saying that yet further air guide ducts may be connected here.

At its end issuing into the vehicle interior 24, the upper air guide duct 16 forms the upper air vent 10 which is in the form of an upper air outlet slot 11, wherein the last section of the upper air guide duct 16 forms an upper issue duct section 17 upstream of the upper air outlet slot 11. At its end issuing into the vehicle interior 24, the lower air guide duct 18 forms the lower air vent 12 which is in the form of a lower air outlet slot 13, wherein the last section of the lower air guide duct 18 forms a lower issue duct section 19 upstream of the lower air outlet slot 13. The respective issue duct sections 17, 19 guide the air flowing in the respective air guide duct 16, 18 to the respective air vent 10, 12 and orient the emerging air flow according to the profile of the respective issue duct section 17, 19, with the result that the issue duct sections 17, 19 determine the air outlet direction Rₒ and Rᵤ.

The upper air outlet direction Rₒ of the air flow Lₒ emerging from the upper air outlet slot 11 is directed slightly obliquely downward (in the negative Z direction) according to the profile of the upper issue duct section 17. The lower air outlet direction Rᵤ to of the air flow Lᵤ emerging from the lower air outlet slot 13 is directed obliquely upward (in the positive Z direction) according to the profile of the lower issue duct section 19. Consequently, the two air flows Lₒ and Lᵤ impinge on one another at a distance from the dashboard 20, are mixed and form a resulting air flow Lᵣ which moves into the vehicle interior 24 in a resulting air flow direction Rr.

An upper additional fan 36 is provided in the upper air guide duct 16 and can be used to accelerate the air flow in the upper air guide duct 16 to the upper air vent 10. In a corresponding manner, a lower additional fan 38 is provided in the lower air guide duct 18 and can be used to accelerate the air flow in the lower air guide duct 18 to the lower air vent 12. The fan 30, the upper additional fan 36 and the lower additional fan 38 can be individually controlled, as a result of which the flow velocity in the upper air guide duct 16 and the flow velocity in the lower air guide duct 18 can be set differently from one another.

Between the upper air vent 10 and the lower air vent 12, the dashboard 20 is provided with a display apparatus 4 which is formed by a two-dimensional display panel 40 in the example shown. This two-dimensional display panel 40, which is in the form of a matrix screen, for example, has a multiplicity of light signal elements which emit light into the vehicle interior 24 when activated.

An upper air sensor 50 of a control device 5 is provided in the upper air guide duct 16 or in the upper issue duct section 17 and captures the air flow velocity or the volumetric air flow in the upper air guide duct 16. This upper air sensor 50 may be an independent air flow sensor, as schematically illustrated in FIG. 1, or may be formed by a speed sensor of the upper additional fan 36. In a similar manner, a lower air sensor 52 is provided in the lower air guide duct 18 and may likewise be in the form of an independent sensor for capturing the flow or may be in the form of a speed sensor of the lower additional fan 38. Both air sensors 50, 52 are connected to a control unit 54 of the control device 5.

In addition to the respective air sensor 50, 52, an upper temperature sensor 51 and a lower temperature sensor 53 may also be respectively provided in the air guide ducts 16, 18 and are likewise illustrated only schematically in FIG. 1.

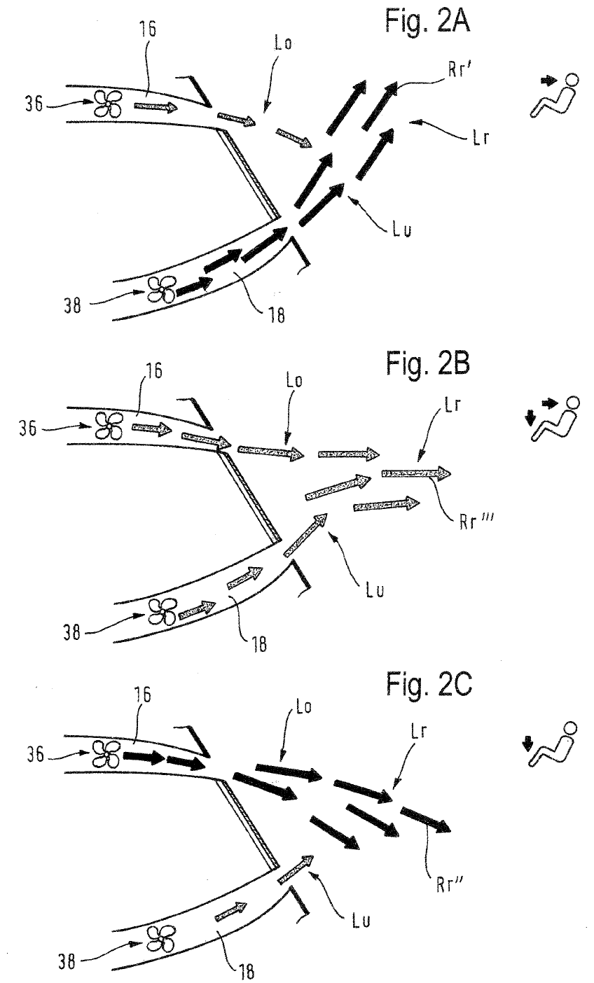

FIGS. 2A to 2C show different operating states of the vehicle interior ventilation system according to the invention. FIG. 2A illustrates a state in which the upper additional fan 36 runs at a lower speed than the lower additional fan 38, with the result that the flow velocity, and therefore the volumetric air flow, in the lower air guide duct 18 is considerably greater than in the upper ventilation duct 16. The lower air flow Lᵤ therefore dominates the resulting air flow Lᵣ which is formed when the lower air flow meets the upper air flow Lₒ, which resulting air flow is directed obliquely upward in the resulting air flow direction Rᵣ′, that is to say is directed at the passenger's head, as symbolically illustrated by the ventilation symbol on the right-hand side of FIG. 2A.

In the state shown in FIG. 2B, the speeds of the upper additional fan 36 and of the lower additional fan 38 are substantially the same, with the result that the same flow velocities also result in the upper air guide duct 16 and in the lower air guide duct 18. The upper air flow Lₒ and the lower air flow Lᵤ are combined in a substantially equivalent manner to form the resulting air flow Lᵣ which is directed at the vehicle occupant substantially in a horizontal direction and therefore provides the vehicle occupant with an approximately uniform air flow in the resulting air flow direction Rᵣ′″, as symbolically illustrated by the ventilation symbol on the right-hand side of FIG. 2B.

FIG. 2C shows a state in which the speed of the upper additional fan 36 is greater than the speed of the lower additional fan 38, with the result that the flow velocity, and therefore the volumetric air flow, in the upper air guide duct 16 is greater than in the lower air guide duct 18. The emerging upper air flow Lₒ therefore dominates the emerging lower air flow Lᵤ, with the result that the resulting air flow Lᵣ is directed obliquely downward in the resulting air flow direction Rᵣ″, as is symbolically illustrated by the symbol on the right-hand side of FIG. 2C.

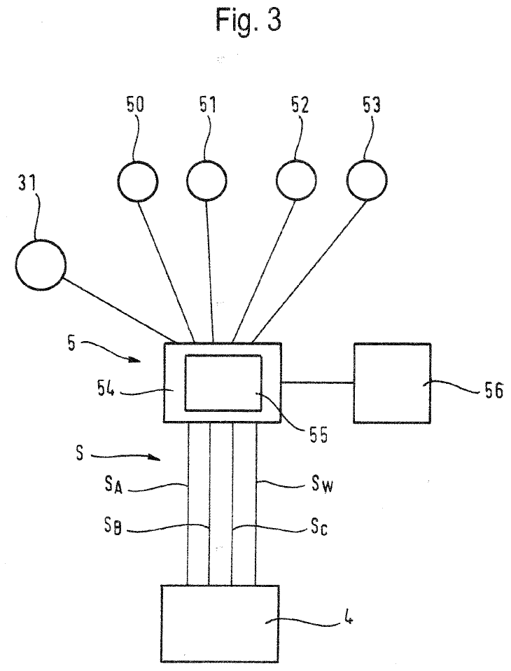

FIG. 3 schematically illustrates the control of the display apparatus 4. A signal proportional to the air flow velocity is respectively transmitted from the upper air sensor 50 and from the lower air sensor 52 to the control unit 54 of the control device 5 in a wireless or wired manner. A temperature signal proportional to the air temperature in the respective air guide duct is likewise transmitted from the upper temperature sensor 51 and from the lower temperature sensor 53 to the control unit 54 in a wireless or wired manner. The control unit 54 also receives other operating signals for the vehicle from vehicle electronics 56 which are illustrated only symbolically in FIG. 3. These signals may comprise, for example, the current driving speed of the vehicle 1 or warning signals. The control unit 54 may also receive a speed signal from a speed sensor 31 of the fan 30.

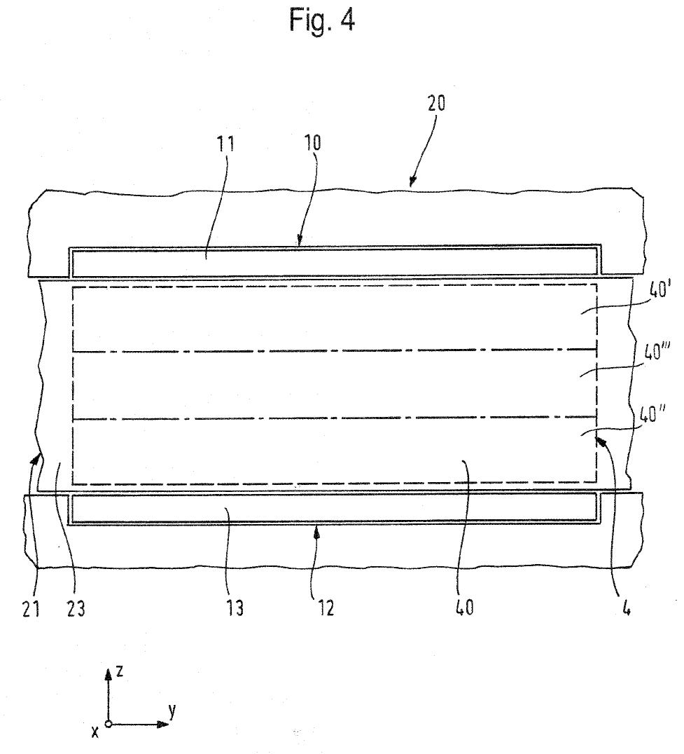

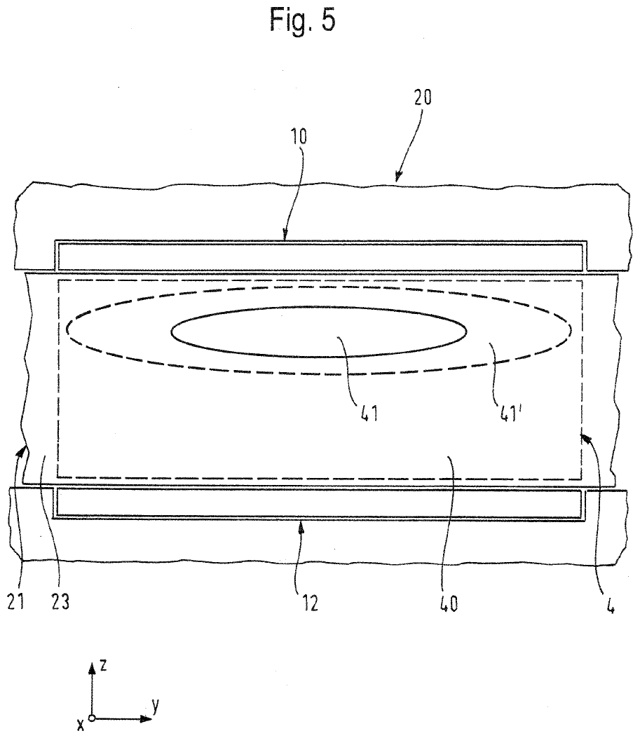

The control unit 54 processes the received signals by means of a control computer 55 provided in the control unit 54 and then transmits control signals S to the display apparatus 4. These control signals may comprise an area extent control signal S_{A}, a region control signal S_{B}, a color control signal S_{C} and/or a warning signal S_{W} or other suitable signals for controlling the display apparatus 4. Different possible ways of controlling the display apparatus 4 are described below on the basis of FIGS. 4 and 5.

FIG. 4 shows a front view of the dashboard 20 from the point of view of a vehicle passenger in the direction of the arrow IV in FIG. 1. The dashboard 20 is only partially illustrated here. The upper air vent 10, which forms an upper air outlet slot 11, and the lower air vent 12, which forms a lower air outlet slot 13, can be seen. The two air vents 10, 12 are arranged at a vertical distance from one another above and below a smart bar 21 in the dashboard 20. The smart bar 21 has a transparent or translucent casing element 23 substantially transversely over the width of the dashboard 20 (Y direction). Different information devices are provided behind the casing element 23 and make visual information visible to the vehicle occupants through the transparent or translucent casing element 23. Such an information device is the display apparatus 4 which is arranged between the two air vents 10 and 12, as illustrated by dashed lines in FIG. 4. This display apparatus 4 has a display panel 40 which is directed at the vehicle occupant and comprises a multiplicity of light signal elements (not shown) and is in the form of an LCD or TFT screen, for example.

The display panel 40 can be divided virtually into three regions, an upper region 40′, a lower region 40″ and a central region 40′″, as is illustrated by way of example using dash-dotted lines in FIG. 4. This division is not a physical division of the display panel 40 but rather is effected merely on the control side, as is explained below.

If the vehicle interior ventilation system is in the operating state shown in FIG. 2A in which the resulting air flow Lᵣ is directed obliquely upward in the resulting air flow direction Rᵣ′, that is to say at the occupant's head, the upper region 40′ of the display panel 40 is illuminated. If the vehicle interior ventilation system 1 assumes the operating state shown in FIG. 2B in which the resulting air flow Lᵣ is directed at the occupant's body in a substantially horizontal manner in the resulting air flow direction Rᵣ′″, the central region 40′″ of the display panel 40 is illuminated. In contrast, if the vehicle interior ventilation system 1 assumes the operating state shown in FIG. 2C in which the resulting air flow Lᵣ is directed obliquely downward into the foot region and at the legs of the occupant in the resulting air flow direction Rᵣ“, the lower region 40” of the display panel 40 is illuminated. In this manner, the vehicle occupant can discern the direction in which the resulting air flow is directed on the basis of the position of the illuminated region of the display panel in the vertical direction.

It is within the discretion of a person skilled in the art to not provide any high-contrast transitions between the illuminated region and the non-illuminated regions when controlling the three regions 40′ 40″, 40′″ of the display panel 40, but rather to configure these transitions with a continuous brightness profile and also to provide intermediate positions.

FIG. 5 shows an alternative form of display which can be combined with the other forms of display. On account of an area extent control signal S_{A} received from the control unit 54, the area extent of the illuminated display region on the display panel 40 can be changed. The area of the oval illuminated display region 41 bounded by a solid line can therefore be increased, as illustrated by the oval display region 41′ depicted using dashed lines, or can be reduced. In this manner, the intensity of the resulting air flow Lᵣ, that is to say the level of the air flow velocity or the magnitude of the emerging volumetric air flow, can be visually displayed, for example. In this case, the smaller illuminated display region 41 represents a less intensive resulting air flow Lᵣ, while the display region 41′ which is larger in terms of the illuminated area represents a more intensive resulting air flow Lᵣ. In this case too, there may be a gradual transition between display regions of different sizes as a function of the air flow velocity or the volumetric air flow.

This form of display for visualizing the air flow intensity can be combined with the form of display in FIG. 4, with the result that the oval display regions 41, 41′ illustrated in FIG. 5 can move over the display panel 40 in the vertical direction and can therefore also indicate the direction of the air flow (as shown in FIG. 4) in addition to the intensity of the latter.

Additional information can be conveyed to the vehicle occupant by choosing the color of the corresponding illuminated display in that the color of the illuminated region displayed on the display panel 40 is displayed on the basis of the determined temperature of the emerging resulting air flow Lᵣ by virtue of a color control signal S_{C} received from the control unit 54. For example, a color transition along the visible color spectrum from green to red via blue or any other arbitrarily selectable color transition may thus symbolize a range for the temperature level of the emerging resulting air flow Lᵣ.

In this manner, three different items of information can be conveyed to the vehicle occupant by means of the display panel 40 of the display apparatus 4, namely an item of information relating to the resulting air flow direction Rᵣ of the emerging resulting air flow Lᵣ, an item of information relating to the intensity of the resulting air flow Lᵣ and an item of information relating to the temperature of the resulting air flow Lᵣ.

As an additional benefit, the display panel 40, under the control of a warning signal S_{W} received from the control unit 54, can display priority warning information which temporarily pushes the displays illustrated in FIGS. 4 and 5 and based on the resulting air flow Lᵣ into the background or hides them, with the result that only the warning information can be seen. If the motor vehicle 2 approaches the end of a traffic jam, for example, without a substantial reduction in the driving speed being able to be determined, an extensive warning signal from an emergency brake assistant can be displayed on the display panel 40 in order to therefore draw the attention of the vehicle occupants, in particular of the vehicle driver, to the imminent hazardous situation. It goes without saying that it is also possible to display other warning signals, for example if a predefined maximum speed is exceeded, without this being described in detail here.

The invention is not restricted to the exemplary embodiment above which is used only to generally explain the core idea of the invention. Rather, the apparatus according to the invention may also assume configurations other than those described within the scope of protection. In this case, the apparatus may have, in particular, features which represent a combination of the respective individual features of the claims.

Reference signs in the claims, the description and the drawings are used only for the better understanding of the invention and are not intended to restrict the scope of protection.

### LIST OF REFERENCE SIGNS

1 Vehicle interior ventilation system
2 Motor vehicle
3 Heating, ventilation and cooling unit
4 Display apparatus
5 Control device
10 Upper air vent
11 Upper air outlet slot
12 Lower air vent
13 Lower air outlet slot
14 Air guide housing
15 Air supply duct
16 Upper air guide duct
17 Upper issue duct section
18 Lower air guide channel
19 Lower issue duct section
20 Dashboard
21 Smart bar
22 Windshield
23 Casing element
24 Vehicle interior
30 Fan
31 Speed sensor of the fan
32 Cooling system heat exchanger
34 Heating heat exchanger
36 Upper additional fan
38 Lower additional fan
40 Display panel
40′ Upper region of the display panel
40″ Lower region of the display panel
40′″ Central region of the display panel
50 Upper air sensor
51 Upper temperature sensor
52 Lower air sensor
53 Lower temperature sensor
54 Control unit
A Active signal area
A1 Active signal area
A1′ Active signal area
A2 Active signal area
A3 Active signal area
A4 Active signal area
F Direction of travel
Lo Upper air flow
Lr Resulting air flow
Lu Lower air flow
R Air flow direction
Ro Air outlet direction at the top
Rr Resulting air flow direction
Rr′ Resulting air flow direction
Rr″ Resulting air flow direction
Rr′″ Resulting air flow direction
Ru Air outlet direction at the bottom
S Control signal
SA Area extent control signal
SB Region control signal
SC Color control signal
SW Warning signal

1.-11. (canceled)

12. A vehicle interior ventilation system, comprising:
at least one fan which is provided in an air guide housing;
at least two air guide ducts fluidically connected to the air guide housing;
air vents, each being fluidically connected to a respective one of the air guide ducts, wherein
at least some of the air vents form at least one upper air outlet slot and at least one lower air outlet slot in a dashboard or a console of the vehicle, from which respective air flows emerge in an air outlet direction predefined by respective issue duct sections of each air vent, wherein the air flows impinge on one another and form a resulting air flow with a resulting air flow direction;
an upper air sensor provided for capturing the air flow velocity or the volumetric air flow in the upper air guide duct or issue duct section leading to the upper air outlet slot;
a lower air sensor provided for capturing the air flow velocity or the volumetric air flow in the lower air guide duct or issue duct section leading to the lower air outlet slot; and
a control unit, of a control device, connected to the upper air sensor and the lower air sensor for transmitting signals,
a display connected to the control unit, the display apparatus being provided in the dashboard or the console, wherein
the control unit is designed to determine the resulting air flow direction of the resulting air flow from the captured air flow velocities or volumetric air flows based on the respective air outlet direction and to form at least one control signal therefrom for application to the display.

13. The vehicle interior ventilation system according to claim 12, wherein
the display comprises light signal elements.

14. The vehicle interior ventilation system according to claim 13, wherein
the display has a two-dimensional arrangement of the light signal elements as a display panel, on which at least one active signal area is displayable.

15. The vehicle interior ventilation system according to claim 14, wherein
the control unit is designed such that a resulting air flow velocity or a resulting volumetric air flow is determined from a magnitude of the air flow velocity or volumetric air flow captured by the respective air sensor, and
an area extent control signal is formed therefrom and is applied to the display such that the area extent of the active signal area displayed on the display panel is dependent on the determined magnitude of the resulting air flow velocity or the resulting volumetric air flow.

16. The vehicle interior ventilation system according to claim 14, wherein
the control unit is designed to control the display by way of a region control signal in such a manner that:
an upper region of the display panel has the active signal area when the resulting air flow direction is directed upward,
a lower region of the display panel has the active signal area when the resulting air flow direction is directed downward, and
a central region of the display panel has the active signal area when the resulting air flow direction is directed in a substantially horizontal manner.

17. The vehicle interior ventilation system according to claim 13, wherein
the light signal elements are designed to reproduce different colors depending on a color control signal.

18. The vehicle interior ventilation system according to claim 17, wherein
the control unit is designed such that a resulting air flow velocity or a resulting volumetric air flow is determined from the magnitude of the air flow velocity or the volumetric air flow captured by the respective air sensor, and
the color control signal is dependent on the magnitude of the resulting air flow velocity or the resulting volumetric air flow.

19. The vehicle interior ventilation system according to claim 17, wherein
at least one temperature sensor is provided in the air guide housing, in the upper air guide duct or issue duct section, and/or in the lower air guide duct or issue duct section,
the control unit is designed to determine a resulting mixing temperature from values of the air temperature captured by the respective temperature sensor based on the respective air flow velocity or the respective volumetric air flow, and
the color control signal is dependent on the determined mixing temperature.

20. The vehicle interior ventilation system according to claim 12, wherein
the display is arranged in the dashboard or the console between the upper air outlet slot and the lower air outlet slot assigned to the latter.

21. The vehicle interior ventilation system according to claim 12, wherein
the control unit applies a warning signal to the display provided in the dashboard, which warning signal causes a priority warning display of the display.

22. A vehicle, comprising:
a dashboard or console; and
at least one vehicle interior ventilation system according to claim 12.
